(19) United States
(12) Patent Application Publication
(10) Pub. No.: US 2021/0370596 A1
(43) Pub. Date: Dec. 2, 2021

(54) CONTROLLING AN ENERGY SOURCE OF AN ADDITIVE MANUFACTURING SYSTEM

(71) Applicant: Hewlett-Packard Development Company, L.P., Spring, TX (US)

(72) Inventors: Hector Vega Ponce, Sant Cugat del Valles (ES); Daniel Rosenblatt, Sant Cugat del Valles (ES); Ismael Fernandez Aymerich, Sant Cugat del Valles (ES)

(73) Assignee: Hewlett-Packard Development Company, L.P., Spring, TX (US)

(21) Appl. No.: 15/734,575

(22) PCT Filed: Feb. 20, 2019
(86) PCT No.: PCT/US2019/018763

§ 371 Date: Dec. 3, 2020

(51) Int. Cl. B29C 64/291; B29C 64/393; B29C 64/295

(52) U.S. Cl. CPC B29C 64/291; B33Y 10/00; B29C 64/295; B29C 64/393

(57) ABSTRACT

Certain examples described herein relate to adjusting an energy source of a 3D printing system. In certain cases, a build bed of a 3D printing system is arranged to receive a layer of build material and the energy source of the 3D printing system is controllable to provide energy to a zone of the build bed. The energy provided by the energy source associated with the zone is adjusted based on a difference between a predetermined heat loss of the build bed and a determined heat loss for the zone, where individual adjustments of energy provided to at least some zones of the build bed collectively provide a uniform heat loss across the build bed.

### BACKGROUND

Additive manufacturing systems, including those commonly referred to as ‘3D printers’, build three-dimensional (3D) objects from selective addition of build material. In one example of additive manufacturing, an object may be generated by solidifying portions of layers of build material. In examples, the build material may be in the form of a liquid, a slurry or a powder. In certain examples, energy may be applied to solidify the portions. To control the portions to be solidified, functional agents may be selectively deposited onto the layers to define the portions solidified.

These additive manufacturing systems may receive a definition of the three-dimensional object, which is interpreted in order to instruct the system to produce the object on a layer-by-layer basis in a build area of the system.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic illustration of a three-dimensional printing system, according to an example;

FIG. 2 is a schematic block diagram of a three-dimensional printing system, according to an example;

FIG. 3 is a flowchart illustrating a method of controlling an energy source of a three-dimensional printing system, according to an example;

FIG. 4 is a flowchart illustrating a method of determining an adjustment for an energy source of a three-dimensional printing system, according to an example.

### DETAILED DESCRIPTION

Three-dimensional printed parts can be generated using additive manufacturing techniques. The printed parts may be generated by applying build material from a material deposit onto a build platform in successive layers and solidifying portions of said successive layers. The build material can be powder-based, and the material properties (mechanical and dimensional) of generated printed parts may be dependent on the type of build material and the printing process. In some examples, solidification of the powder material is enabled using a liquid fusing agent. In other examples, solidification may be enabled by temporary application of energy to the build material. In certain examples, fuse and/or bind agents are applied to build material, wherein a fuse agent is a material that, when a suitable amount of energy is applied to a combination of build material and the fuse agent, causes the build material to fuse and then to solidify upon cooling. In other examples, other build materials and other methods of solidification may be used. In certain examples, the build material includes paste material, slurry material or liquid material. A build platform may also be referred to as a build bed, build area, or print area.

After the selective solidification of each layer the non-solidified build material may be removed from the build platform to leave a printed object, which may be sintered in a furnace.

Examples of build materials for additive manufacturing include polymers, crystalline plastics, semi-crystalline plastics, polyethylene (PE), polylactic acid (PLA), acrylonitrile butadiene styrene (ABS), amorphous plastics, Polyvinyl Alcohol Plastic (PVA), Polyamide (e.g., nylon), thermo(setting) plastics, resins, transparent powders, colored powders, metal powder, ceramics powder such as for example glass particles, and/or a combination of at least two of these or other materials wherein such combination may include different particles each of different materials or different materials in a single compound particle. Examples of blended build materials include alumide, which may include a blend of aluminum and polyamide, and plastics/ceramics blends. There exist more build materials and blends of build materials that can be managed by an apparatus of this disclosure and that are not mentioned in this disclosure.

In example additive manufacturing systems, also referred to as three-dimensional (3D) printing systems, the build material may be heated prior to fusing. This heating is performed by energy sources positioned adjacent, and commonly above, the build bed, sometimes referred to as “top lamps”, which transmit radiative energy and thereby provide thermal energy to build material received on the build bed.

Often, the amount of energy provided by the energy sources is controlled by settings stored in a memory of the printing system during manufacture of said printing system. However, due to hardware and printing process asymmetries, printing conditions across a build bed may differ significantly, which can lead to variation in quality and properties of a part printed using such a system.

The inventors have realized that such variations may be overcome by addressing variations in heat loss by convection across the build bed. Upon arriving at this realization, the inventors developed the herein described method and 3D printing system to enable real-time calibration of energy sources within said system to achieve uniform heat loss across the build bed. The “real-time” calibration may occur between different, sometimes consecutive, printing jobs, whereby heating of build material of an upcoming printing job is based on an evaluation of heat loss of build material in a previous printing job. In another example, the “real-time” calibration may occur as a current printing job is being performed, whereby such calibration is based on heat loss of deposited material within a single layer of a printed object to inform how to heat the current and/or next layer of build material. The term “uniform” may be regarded as meaning that the heat loss is substantially the same across the build bed. In some examples, this may be determined up to a number of significant figures or decimal places and/or based on a predefined margin of error.

Examples described herein provide more consistent heat loss conditions across a layer of build material on a build bed through independent calibration of heat sources corresponding to respective areas of the build bed and thus portions of the build material, thereby improving and achieving more consistent quality between different printed parts and different printers. Such advantages may have a significant effect in mass production manufacturing processes.

The term “heat loss by convection” is used to refer to the transfer of energy from a surface of the build material to air particles proximal the build material.

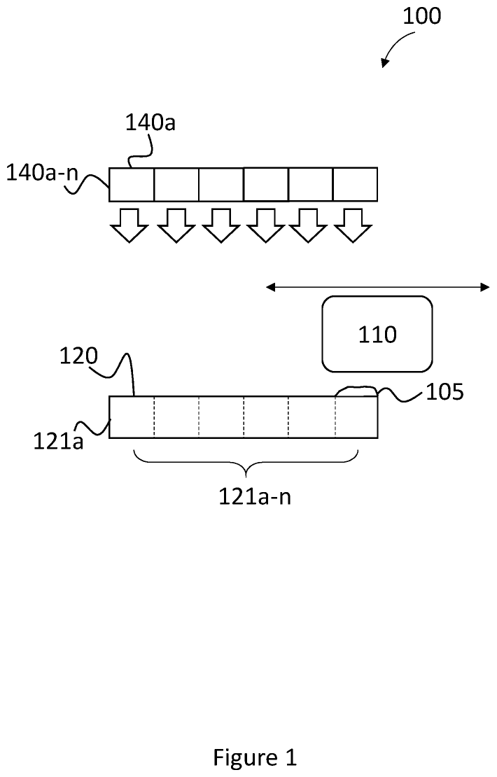

FIG. 1 is a schematic illustration of a three-dimensional printing system 100. The 3D printing system 100 has a build bed 120, a plurality of energy sources 140a-n and a build material depositing means 110.

The build material depositing means 110 is controllable to traverse the build bed 120 in a reciprocating motion (as indicated by the double headed arrow). The depositing means 110 is also controllable to form a layer of build material 105 on the build bed 120 by depositing build material 105 as the depositing means 110 moves over the build bed 120, with either every pass or every alternate pass. As an example, the build material depositing means 110 may be a carriage containing a quantity of build material 105 that is deposited as the carriage moves. Alternatively, the material depositing means 110 may be a sweeping or rolling mechanism that deposits a quantity of build material onto the build bed 120 by moving said material from an area surrounding of the build bed 120 as the depositing means 110 moves from one side of the build bed 120 to the other.

The build bed 120 may be divided into a plurality of evenly distributed and uniformly dimensioned zones 121a-n, as indicated by the dotted lines in FIG. 1. Such division is illustrative rather than a physical division of the build bed 120. Each of the plurality of zones 121a-n is arranged to receive build material deposited thereat and associated with a corresponding energy source of the plurality of energy sources 140a-n. Thus, whilst the dotted lines are present on the side of the build bed 120 in FIG. 1, each of the plurality of zones 121a-n should be considered as being defined on the uppermost surface (not shown) of the build bed 120 onto which the build material depositing means 110 will deliver build material 105. In one example, at least one or some of the plurality of energy sources 140a-n may be a heat lamp. In one example, all of the energy sources 140a-n are heat lamps. In another example, the build bed 120 may be divided into a plurality of zones, for example, by marking zones onto the build bed by etching, engraving, adding grooves or ridges, and/or applying ink or other marking element to the surface of the build bed.

As an example, the zone 121a corresponds to the energy source 140a, whereby said corresponding relationship is determined based on the relative positioning of the energy source 140a to the zone 121a. In the example of FIG. 1, the energy source 140a is located above the zone 121a. In addition, there is a one-to-one relationship between each of the plurality of energy sources 140a-n and the plurality of zones 121a-n. Each of the energy sources 140a-n is controllable to apply energy (as indicated by the arrows) to build material deposited in a corresponding zone in order to heat said material to a specific temperature and/or maintain the material at said specific temperature. In one example, at least some of the energy sources 140a-n are controllable to deliver energy to the build material prior to fusing of the build material, which is achieved by applying higher energy to the build material, commonly by another energy source, for example, a scanning fusing lamp, or a laser.

Whilst the example of FIG. 1 contains six energy sources and six zones of the build bed, in other examples there may more or fewer energy sources and/or zones.

In one example, the plurality of energy sources 140a-n heats the build material before the material is solidified. In this way, more consistent fusing conditions are achieved across the build bed 120.

In some examples, the division of zones may be based on the dimensions of each of the energy sources and/or an area in which a predetermined proportion of energy transmitted by an energy source is predominantly received.

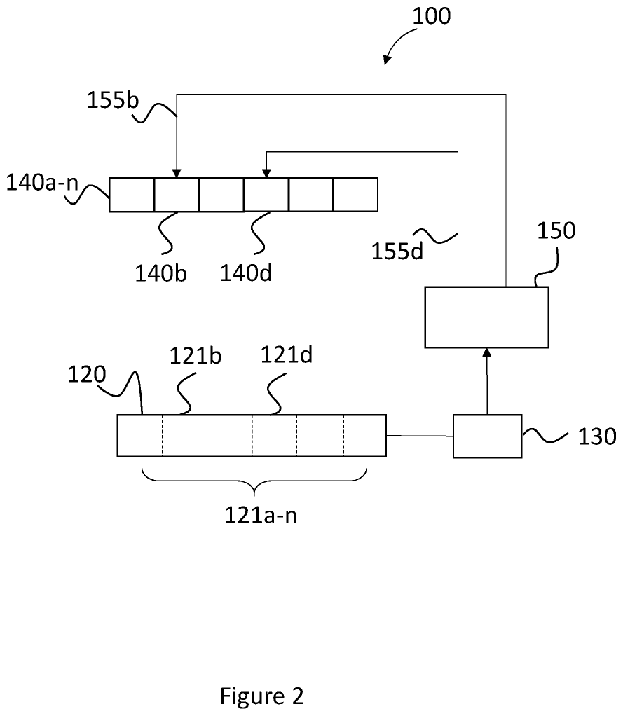

In another example, the relationship between each of the plurality of energy sources 140a-n and the plurality of zones 121a-n may be two to one or three to one, depending on a desired level of precision in maintaining more consistent conditions across the build bed 120 (described in relation to FIG. 2). In one example, at least some of the plurality of energy sources 140a-n and the build bed 120 may be controllable to move relative to one another so that said energy sources deliver energy to each of the zones 121a-n. In one scenario, at least some of the plurality of energy sources 140a-n may traverse the build bed 120 in order to deliver energy to each of the plurality of zones 121a-n.

In another example, the plurality of zones may not be evenly distributed across the build bed 120 or uniformly dimensioned. Instead, a higher number of zones may correspond to a first predefined area of the build bed 120 compared to a second predefined area of the build bed, where the first and second predefined areas are the same size. As above, distribution of zones across the build bed may depend on a desired level of precision in maintaining certain conditions across the build bed 120, or a sub-area thereof.

FIG. 2 is a schematic block diagram of the three-dimensional printing system 100 of FIG. 1 and provides further detail on the same.

The 3D printing system 100 has a sensor 130 coupled to the build bed 120. The system 100 also has a controller 150 coupled to the sensor 130 and each of the plurality of energy sources 140a-n.

The sensor 130 is controllable to monitor the temperature of the build material (105, FIG. 1) in each zone 121a-n of the build bed 120. Data representative of temperatures in each of the plurality of zones 121a-n is provided, by the sensor 130, to the controller 150, so that any change in temperature of said build material within a predetermined time period can be determined by the controller 150. In one example, the sensor 130 is positioned above the build bed 120 and may be a thermal imaging camera, which generates a thermal energy pattern based on infrared light emitted by the build material in one or more of the plurality of zone 121a-n and detected through the optical lens of the camera. In one example, the sensor 130 may be positioned such that its field of view may encompass the majority of or the whole of the build bed 120.

The controller 150 is controllable to execute computer readable instructions stored in a memory (not shown) and, as a result of such execution, adjust the output energies of at least some of the plurality of energy sources 140a-n based on a difference between a predetermined heat loss of the build bed 120 and the determined heat loss for the zone 121a-n, wherein individual adjustments of output energy for at least some of said zones 121a-n collectively provide a uniform heat loss across the build bed 120. The determined heat loss may correspond to a decrease in thermal energy of the build material, which can be represented by a drop in temperature (for example, in Celsius ° C.) or as a cooling rate: temperature drop over time (for example, in Celsius per second ° C./s). A predetermined heat loss may be stored in a memory component (not shown) accessible to the controller 150.

In particular, the controller 150 provides one or more signals 155a-n to at least some of the energy sources 140a-n to control their respective output energies, based on a determined heat loss in the respective zones 121a-n of the build bed 120, wherein the heat loss for each zone 121a-n is determined using the temperature change of the build material (105, FIG. 1) received thereat. As discussed earlier, in one example, the output energies of the energy sources 140a-n may be controlled so that a current layer of build material on the build bed 120 experiences a change in the amount of energy received from the energy sources 140a-n and hence a change in heat loss. In this way, consistent fusing conditions are achieved for the current layer ahead of a selective fusing process for said layer. Alternatively, the output energies of the energy sources 140a-n may be controlled so that a subsequent (or the next) layer of build material experiences a change in the amount of energy received from the energy sources 140a-n and hence a change in heat loss. In this way, consistent fusing conditions are achieved for the following layer of build material (based on an evaluation of the current layer) ahead of a selective fusing process for the following layer.

In the example of FIG. 2, the controller 150 provides a signal 155b to the energy source 140b and a signal 155d to the energy source 140d based on a determined heat loss of the corresponding zones 121b and 121d of the build bed. In this scenario, the determined heat loss of both zones 121b,d is different from a predetermined heat loss for the whole of the build bed 120 and, as a result, each of the signals 155b and 155d applies a corrective input to the respective energy source to cause the heat loss for said zones to align with that of the rest of the build bed 120. The content of the signal 155 may be different for each of the energy sources 140b,d.

Generally, a signal 155a-n sent by the controller 150 controls the recipient energy source and is representative of a corrected initial input signal for the corresponding energy source 140a-n. In some examples, the initial input signal may be a factory or manufacturing setting stored in a memory component of a 3D printing system, such as the system 100, or a previously calibrated signal.

In another example, the sensor 130 may be one of the following: a thermocouple; a resistive temperature detector; a thermistor; and an infrared sensor.

In another example, the sensor 130 may comprise a plurality of sensors 130a-n, where at least one sensor corresponds to each of the plurality of zones 121a-n.

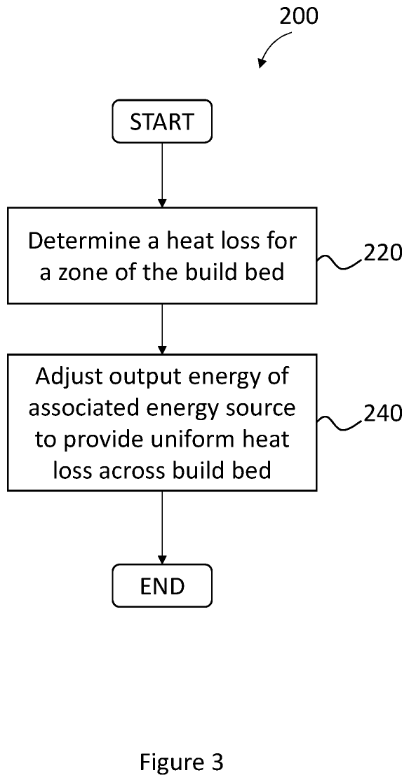

FIG. 3 is a flowchart illustrating an example method 200 of controlling an energy source of a three-dimensional printing system, specifically, a build bed of such a system as described in relation to FIGS. 1 and 2. Method 200 is carried out by the controller 150 of FIGS. 1 and 2. The method 200 can be carried out: between completion of consecutive printing jobs; and/or after a first layer has been deposited on the build bed and before a succeeding, second layer is deposited on the build bed; and/or after a layer of build material has been deposited on the build bed and before initiation or completion of a selective fusing process on said layer; and/or as portions of build material are being deposited on the build bed and before a complete layer has been completely deposited or before initiation or completion of a selective fusing process on said complete layer.

At block 220, a heat loss for a zone 121a of the build bed 120 is determined using a determined temperature decrease of build material 105 deposited at the zone 121a.

At block 240, the output energy of an energy source associated with the zone 121a is adjusted in order to provide uniform heat loss across the build bed 120.

The method 200 may be carried out for each zone 121a-n of the build bed 120, either concurrently or sequentially. The active determination of a heat loss of a zone described in relation to block 220 is optional. In some examples, the determination of block 220 may be replaced by an obtaining step, whereby a representation of heat loss for a zone of a build bed is obtained by the controller 150, where in some examples, the representation may have been measured or determined by a component other than the controller 150.

Method 200 may be carried out after a first print has been performed by the printing system after the system has been turned on. Alternatively, or additionally, method 200 may be carried out before each print job is initiated. In another example, the determination of block 220 may be continuously carried out during a printing process.

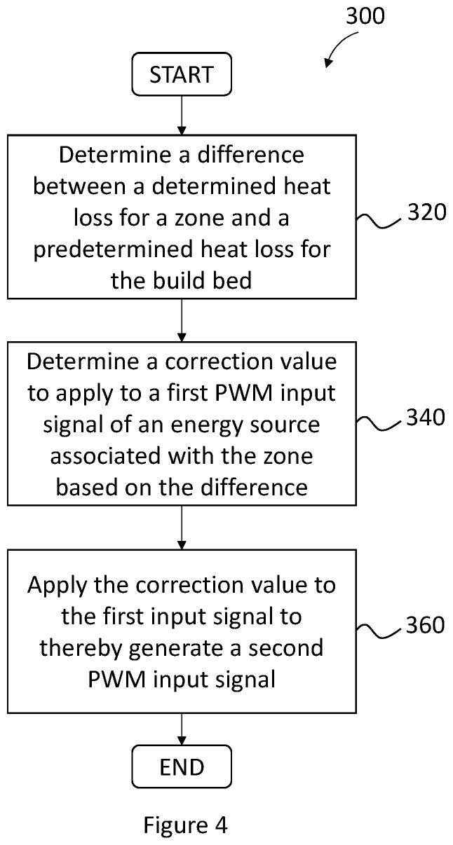

FIG. 4 is a flowchart illustrating an example method 300 of determining an adjustment for an energy source of a three-dimensional printing system, specifically, a build bed of such a system. Method 300 provides further detail to method 200 and may be carried out between the determination of block 220 and the adjustment of block 240. Method 300 is carried out by the controller 150 of FIGS. 1 and 2.

At block 320, a difference between a determined heat loss for a zone and a predetermined heat loss for the build bed is determined.

At block 340, a correction value to apply to a first pulse width modulation, PWM, input signal of an energy source associated with the zone based on the difference is determined. The use of a PWM signal as the input to each of the energy sources can result in near-consistent behavior of the respective energy source, helping to maintain uniform delivery of energy by the respective energy source to the build material in the corresponding zone of the build bed 120.

At block 360, the correction value is applied to the first input signal to thereby generate a second PWM input signal, whereby the second PWM signal is provided to the respective energy source and causes adjustment of its output energy.

In one example, the following formula, Equation 1, embodies blocks 320 to 360:

PWM₂=PWM₁−A(T₃−T₄−ΔT_{N}) Equation 1

where: PWM₂ is a second PWM input signal; PWM₁ is a first initial input signal, that is initially input to a corresponding energy source and may correspond to a factory setting for the printing system; A is a constant that describes the number of degrees (temperature) that change by increasing the PWM by a single point, which varies according to the characteristics of the energy source in question and its distance from the build bed; T₃ is a first sensed temperature; T₄ is a second sensed temperature; and ΔT_{N} is a predetermined temperature decrease, which may be considered as a target or desired temperature decrease for the build bed as a whole.

The difference between a determined (actual) heat loss and a predetermined heat loss can be considered as the “T₃−T₄−ΔT_{N}” of Equation 1. The correction value incorporates said difference and can be considered as the “A(T₃−T₄−ΔT_{N})” term of Equation 1.

If the actual heat loss equals the predetermined heat loss the correction value is zero and therefore PWM₂ equals PWM₁ and, thus, in such a scenario no change is made to the input of the corresponding energy source.

If the actual heat loss is less than the predetermined heat loss the correction value is negative, resulting in PWM₂ having a greater value than PWM₁. Accordingly, if the actual heat loss is greater than the predetermined heat loss the correction value is positive, resulting in PWM₂ having a smaller value than PWM₁.

As an example, the correction value may a voltage parameter, Volts, V. In another example, the correction value may relate to a duty cycle of the PWM signal, such as an increase or decrease in the duty cycle, and may result in a change in frequency of the PWM signal.

Application of Equation 1 in determining a corrected PWM signal compensates for different heat losses across the build bed and, consequently, achieves a uniform heat loss and a uniform final temperature across the build bed.

Whilst method 300 is explained with reference to first and second PWM signals, the method 300 may also be implemented by an analog system that uses an analog controller and an electrical circuit to implement a corresponding algorithm to that represented by Equation 1 to correct a first analog input signal and generate a second analog signal. In such a scenario, the correction value may relate to voltage, current, or frequency of the input signal.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method of adjusting an energy source for a build bed, the build bed arranged to receive a layer of build material, the energy source controllable to provide energy to a zone of the build bed, the method comprising adjusting the energy provided by the energy source associated with the zone based on a difference between a predetermined heat loss of the build bed and a determined heat loss for the zone, wherein individual adjustments of energy provided to at least some zones of the build bed collectively provide a uniform heat loss across the build bed.

2. The method of claim 1, comprising determining a temperature decrease of said build material deposited at the zone, thereby determining a heat loss for the zone.

3. The method of claim 1, wherein each zone of the build bed has an energy source associated therewith, the method further comprising adjusting the output of each energy source associated with a zone of the build area having a determined heat loss that is not the same as the predetermined heat loss of the build bed.

4. The method of claim 3, wherein adjusting the output of an energy source comprises applying a correction value to an input signal of the energy source to align the determined heat loss to the predetermined heat loss of the build bed.

5. The method of claim 4, comprising determining, based on the difference between the determined heat loss for the zone and the predetermined heat loss of the build bed, the correction value to apply to the input signal of the energy source associated with the zone.

6. The method of claim 5, wherein the input signal of the energy source is initially a first pulse width modulation, PWM, signal and the correction value changes the voltage of the first PWM signal and thereby generates a second PWM signal.

7. The method of claim 1, wherein the determined heat loss is heat loss by convection.

8. An additive manufacturing system comprising:
a print area comprising a plurality of zones for receiving build material;
a plurality of energy sources arranged relative to the print area, wherein each energy source is controllable to deliver thermal energy to at least one zone of the print area;
a sensor controllable to monitor the temperature of build material in each zone of the print area; and
a controller controllable to provide a signal to at least some of the energy sources to control their respective transmitted energies, based on a determined heat loss in the respective zones of the print area, wherein the heat loss for each zone is determined based on a temperature change of the build material received thereat.

9. The additive manufacturing system of claim 8, wherein the controller is controllable to control the transmitted energies of the at least some energy sources that are associated with a zone having a determined heat loss that is not the same as a predetermined heat loss for the print area.

10. The additive manufacturing system of claim 9, wherein the controller is controllable to apply a correction value to an input signal of the respective at least some energy sources to align the determined heat loss to the predetermined heat loss.

11. The additive manufacturing system of claim 8, wherein the controller is controllable to determine, based on the difference between the determined heat loss for each zone associated with the at least some energy sources and the predetermined heat loss for the print area, the correction value to apply to the respective input signals of the at least some energy sources associated with the respective zone.

12. The additive manufacturing system of claim 11, wherein each of the respective input signals of the at least some energy sources is initially a first pulse width modulation, PWM, signal and the correction value changes the voltage of the first PWM signal and thereby generates a second PWM signal.

13. The additive manufacturing system of claim 8, wherein the determined heat loss is heat loss by convection.

14. A computer readable medium comprising a set of instructions, that, when executed by a processor of a printing system cause the processor to: for each area of a build bed:
determine a cooling rate of material deposit thereat; and
apply a correction to a signal input to an energy source arranged to provide energy to the area, wherein the correction is based on a difference between a heat loss of said area determined using the cooling rate and a target heat loss;
whereby the respective corrections are specific to the energy source and align the heat loss per area to the target heat loss.
